(19) United States
(12) Patent Application Publication
(10) Pub. No.: US 2026/0042915 A1
(43) Pub. Date: Feb. 12, 2026

(54) OPTICAL MATERIALS AND METHODS THEREOF

(71) Applicant: Star Voltaic, LLC, Indianapolis, IN (US)

(72) Inventor: CHRISTOPHER BENSON, Indianapolis, IN (US)

(73) Assignee: Star Voltaic, LLC, Indianapolis, IN (US)

(21) Appl. No.: 19/101,534

(22) PCT Filed: Aug. 7, 2023
(86) PCT No.: PCT/US2023/071798

§ 371 Date: Feb. 5, 2025

Related U.S. Application Data
(60) Provisional application No. 63/395,401, filed on Aug. 5, 2022.

(51) Int. Cl. C09B 67/20; C08J 5/18; C08K 5/29; C08K 5/315; C08K 5/357; C09B 11/24; C09B 19/00; H01S 3/16

(52) U.S. Cl. CPC C09B 67/0063; C08J 5/18; C08K 5/29; C08K 5/315; C08K 5/357; C09B 11/24; C09B 19/00; H01S 3/168; C08J 2369/00

(57) ABSTRACT

A small molecule ionic isolation lattice (“SMILES”)-doped polymeric gain media for use in solid state dye lasers. The SMILES-doped polymeric gain media can comprise a polymer component and a SMILES component. The SMILES component can include a dye element, a counterion element, and a receptor element. In some exemplary embodiments, the SMILES composite can include the following formula: a (dye^{m+})x·(counterionn)y·(receptor)z, wherein values of m, n, x and y may be integers greater than or equal to 1.

### CROSS-REFERENCE TO RELATED APPLICATION

This U.S. patent application claims priority to U.S. Provisional Application 63/395,401 filed Aug. 5, 2022, which is considered part of the disclosure of this application and is hereby incorporated by reference in their entirety.

### FIELD OF THE INVENTION

This invention relates generally to the production of gain medium and other optical materials for solid-state dye lasers. In one aspect, the present disclosure relates to creation of solid-state gain media containing small-molecule, ionic isolation lattices (“SMILES”) as the optically active component.

### BACKGROUND

Originally developed in the 1960s, dye lasers were one of the earliest classes of laser, and the first class of laser that had widely tunable emission properties. Conceptually, lasers are comprised of three components: A pump source, which provides energy; gain medium, which absorbs pump energy and converts it to light; and a resonator, which amplifies the light emitted by the gain medium, producing the distinctive laser beam. The characteristic distinguishing dye lasers from their predecessors was that their gain medium was liquid, a circulating solution of fluorescent dye (e.g., rhodamine derivatives, commonly referred to as “laser dyes”) generally dissolved in organic solvents replacing inorganic glasses containing small quantities of photoactive dopant ions dispersed in an optically inactive bulk (e.g., the presence of chromium(III) in a matrix of Al₂O₃) serving an analogous role to the dye molecules. This analogy inspired an intuitive transition for dye lasers from a liquid state to solid substituting optically inert liquids with optically inert solids, i.e., polymers. Within a year of the initial publication of a dye laser with liquid gain medium, the first example of a dye laser featuring a solid embodiment was reported. Several decades of development in polymer-based dye laser gain medium ensued.

The performance of solid-state dye lasers have been consistently hindered by the intrinsic incompatibilities of fluorescent dyes and polymer matrices. Specifically, it has been observed that beyond critical concentration thresholds, laser performance was greatly reduced or suppressed entirely, a threshold that varied with the composition of the polymer. This incompatibility arises from a well-understood physical process: The self-association of dye molecules, sometimes described as “concentration quenching”. The propensity for self-association is aggravated by their inclusion into polymers as polymers can create distinct phase boundaries as they solidify, and the resulting phase separation drives dye molecules into the boundary regions, creating areas with high local dye concentrations and encouraging the formation of dye aggregates. In addition to attenuating lasing performance, aggregation also limits the robustness of polymer gain media. Non-emissive relaxation processes dissipate the energy of the excited state as heat; as such, the presence of dye aggregates generates large quantities of heat in the medium that cannot be efficiently managed owing to the poor thermal conductivity of polymers. This results in the onset of several failure modes for the gain medium including thermal lensing, and even scorching/burning of the polymer material impairing the optical amplification process.

Historically the need to avoid aggregation in solid state gain media had been overcome by dispersing fluorescent dyes in polymer at low concentrations but this merely exchanged one set of problems for another. Lower dye concentrations do indeed reduce the severity of aggregation-caused quenching but (a) low concentrations of dyes in the polymer limit the maximum power output and (b) this only reduces quenching, it does not eliminate it. Significant cavity losses, low lasing efficiencies, and high threshold powers are still observed. Consequently, a gain medium that was not affected by quenching at all would represent a significant technological development in this area and a great deal of effort has been invested to realize such materials. One area of effort is synthetic solutions, in which steric bulk is added to the fluorophore to discourage aggregation, but this solution is inefficient, adding extra steps of custom synthesis and purification that are not broadly applicable or modular. Additionally, the problem has been that concentration quenching negates gains in fluorophore density by sharply reducing quantum yield.

There exists a need for an improved gain medium that are immune to concentration quenching, so high concentrations can be achieved while retaining intense emission. Additionally, there is a need for a gain medium that can increase fluorophore density without a problematic decrease in quantum yield.

### BRIEF SUMMARY OF THE INVENTION

In one aspect, the present disclosure is related to the composition and method of preparing a variety of media for this purpose and supplies representative data that illustrates the significant performance advantages of the SMILES gain media in generating laser output.

In another aspect, the present disclosure is related to a SMILES-doped gain media can include a polymeric host component and a SMILES component. The polymeric host component can comprise between 90-99.99% of the SMILES-doped polymeric gain media by weight. The SMILES component can comprise between 0.01-10% of the SMILES-doped gain media by weight. In some exemplary embodiment, the SMILES component can be selected from a group of compounds having at least one of the following formulas: (charged dye^{m+})x·(counterionⁿ⁻)y·(counterion receptor)z, wherein the charged dye^{m+} is a cationic dye, the counterionⁿ⁻ is an anion, and the counterion receptor is a binding ligand for the counterionⁿ⁻. The values of m, n, x and y are integers greater than or equal to 1 and products of x·n and m·y are identical; or (charged dye^{m-})x·(counterionⁿ⁺)y·(counterion receptor)z, wherein the charged dye^{m-} is an anionic dye, the counterionⁿ⁺ is a cation, and counterion receptor is a binding ligand for counterionⁿ⁺. The m, n, x and y are integers greater than or equal to land products of x·n and m·y are identical. In some exemplary embodiments, the ratio of first charged dye:second charged dye can be between 100:1 to 1:100.

In another aspect, the present disclosure relates to materials and methods for optics applications, including but not limited to laser gain media, optical amplification, and sensing. Polymer materials can have one or more SMILES added to generate a highly fluorescent solid. The resulting fluorescent solid can then be utilized as an active material for laser gain media or light capture and transmission.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DESCRIPTION OF DRAWINGS

FIG. 1 is a schematic showing the structure of cyanostar and its basic interaction with a canonical laser dye, Rhodamine 6g.

FIG. 2 is an illustration showing the series of intermolecular interactions that give rise to SMILES materials.

FIG. 3 is a photograph of polymer films under white light and UV light irradiation showing the significant enhancement of fluorescence imparted by SMILES.

FIG. 4 is an illustration of molecular structures of ion receptors for an exemplary embodiment of a SMILES-tinted gain media of the present disclosure.

FIG. 5 is an illustration of molecular structures of ion receptors for an exemplary embodiment of a SMILES-tinted gain media of the present disclosure.

FIG. 6 is a diagram of an exemplary embodiment of a sandwich slab gain medium of the present disclosure.

FIG. 7a is a graphical illustration of the spectral properties of SMILES-rhodamine 6G gain medium of the present disclosure.

FIG. 7b is a graphical illustration of the spectral properties of the R6G corresponding control material of the present disclosure.

FIG. 8 is an illustration comparing the maximum output power and conversion efficiency for solid SMILES-rhodamine 6G, solid rhodamine 6G control, and liquid rhodamine 6G control of the present disclosure.

FIG. 9 is a graphical illustration of the emission properties of an exemplary embodiment of a SMILES-rhodamine 6G film of the present disclosure under down-conversion and up-conversion excitation conditions.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “exemplary”, “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present disclosure relates to materials and methods for optics applications, including but not limited to laser gain media, optical amplification, sensing, and other optical materials to support those applications (e.g., solid filters or saturable absorbers). Polymer materials can have one or more SMILES added to generate a highly fluorescent solid. The resulting fluorescent solid can then be utilized as an active material for laser gain media or light capture and transmission.

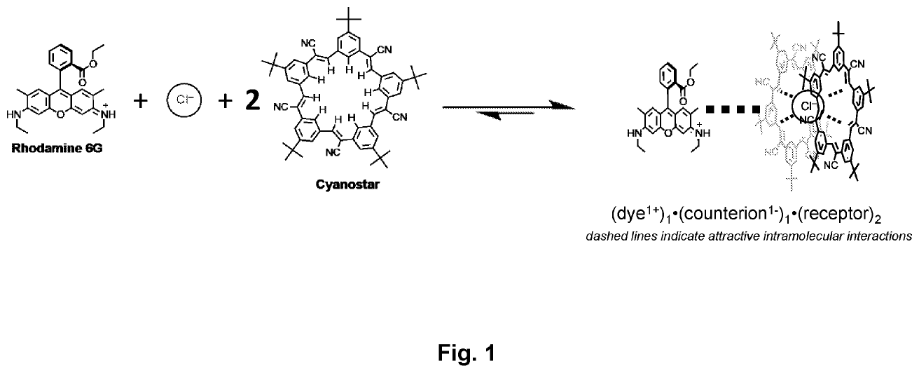

SMILES are self-assembled structures that can mimic the spatial arrangement of fluorophores in the photosynthetic pigments of plants. Like the molecular arrays in the light harvesting complex, fluorescent dyes in SMILES are dispersed into an organized lattice that spatially and electronically isolate them from one another. This isolation disrupts the intermolecular interactions that cause exciton coupling and quenching. The formation of these lattices is facilitated by a series of programmed supramolecular interactions directed by a macrocyclic anion receptor called “cyanostar” (FIG. 1). In some exemplary embodiments, the counterion receptor can be added in excess of the ion to favor formation of a SMILES lattice.

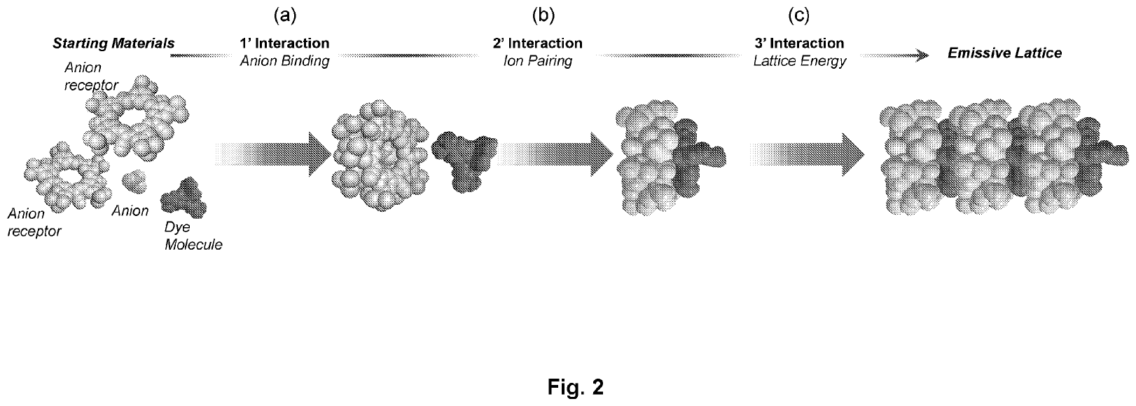

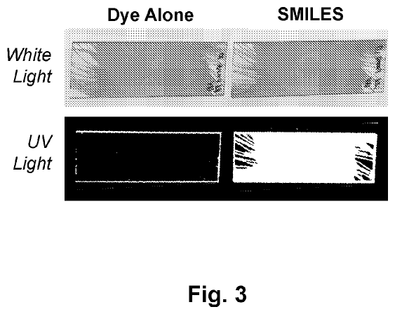

As shown in FIG. 2, SMILES can be the product of a multistep hierarchical assembly: Anion binding by cyanostar is the primary interaction (a). The strength of these interactions can be very high, with Ka≈1012 for two cyanostars binding charge-diffuse guests like perchlorate and heterocyclic radicals. The secondary interaction in a SMILES lattice is formed by attractive ion pairing between the negatively charged cyanostar-anion complex and a countercation (b). In the context of SMILES, in some exemplary embodiments a counterion can be played by the cationic fluorescent dye. Long-range ionic packing forces then assemble these ion pairs into lattices, representing the tertiary interaction (c). The structured lattice that can be generated can reproduce the environment that dyes experience in dilute solution, resulting in highly emissive materials. FIG. 3, illustrates the aggregation of rhodamine within a polymer results in a loss of fluorescence that is rescued by the presence of cyanostar. Exemplary embodiments of the composition of the present disclosure have provided the highest volume-normalized brightness of any materials platform currently known and can include utilizing one or more select dyes to tailor emission wavelength, charge-transfer states, and creation of extended Förster resonance energy transfer (FRET) arrays.

SMILES can include solid materials characterized by the following general formulas: (charged dye^{m+})ₓ·(counterionⁿ⁻)_{y}·(counterion receptor)_{z}, wherein the charged dye^{m+} is a cationic dye, the counterionⁿ⁻ is an anion, and the counterion receptor is a binding ligand for the counterionⁿ⁻. The values of m, n, x and y are integers greater than or equal to 1 and products of x·n and m·y are identical; or (charged dye^{m-})x·(counterionⁿ⁺)y·(counterion receptor)z, wherein the charged dye^{m-} is an anionic dye, the counterionⁿ⁺ is a cation, and counterion receptor is a binding ligand for counterionⁿ⁺. The m, n, x and y are integers greater than or equal to 1 and products of x·n and m·y are identical. In some exemplary embodiments, the SMILES component can have a ratio of about one part charged dye component to about two parts receptor components. In other embodiments, the SMILES component can have a ratio of about one part charged dye component to about one part receptor component. In some exemplary embodiments of a SMILES-doped gain media of the present disclosure, the polymeric host component can comprise between 90-99.99% of the SMILES-doped polymeric gain media by weight and the SMILES component can comprise between 0.01-10% of the SMILES-doped gain media by weight.

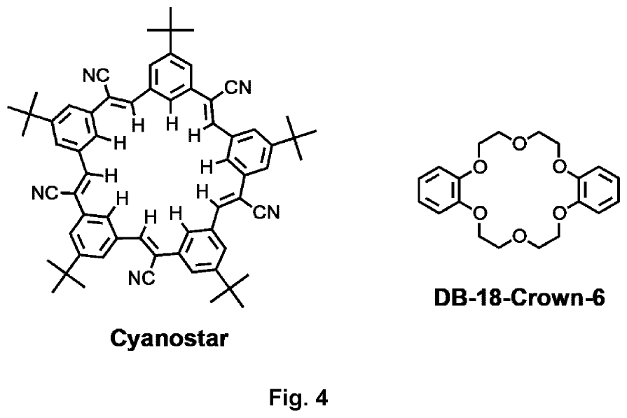

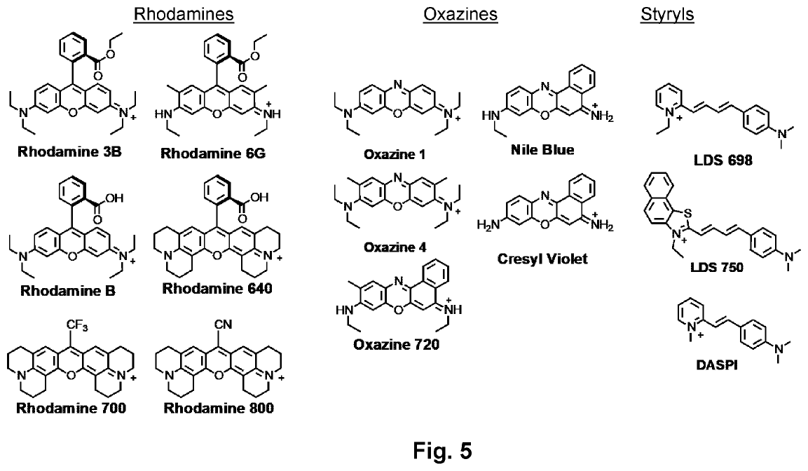

In some exemplary embodiments, the charged dye element can be ion receptors that can be used in SMILES gain media are shown in FIG. 4 and can include cyanostar (for cationic dyes) and dibenzo-18-crown-6. In some exemplary embodiments, the dye element can be any molecule bearing one or more positive or negative charges and an accompanying counterion. FIG. 5 illustrates some exemplary embodiments of dyes that can be utilized of the present disclosure. Additionally, some exemplary dyes can be members of major classes of fluorescent dye, such as xanthine, oxazine, rhodamine, styryl, cyanine, thiazole, coumarin, dipyrromethene etc. Other exemplary charged dyes can include styryls, xanthenes, trianguleniums, oxazines, triarylmethanes, cyanines, acridines, fluoronones, phenanthridines, polyaromatic hydrocarbons, imides, BODIPYs, coumarins, and squaraines, or a combination thereof.

SMILES components can be used to produce several morphologies of the gain medium. These include (1) slabs (i.e., continuous bulks of cuboid shape); (2) rods (i.e., continuous bulks of cylindrical shape); (3) lenses (i.e., generally elliptical shapes with concave or convex faces, in the form of either stand-alone structures or mounted on a substrate such as a mirror or piece of glass); (4) polyhedra (i.e., bulks containing SMILES in the shape of prisms, octahedra, or other shapes designed to direct the path of light); (5) films (i.e., flat coatings over a substrate such as a mirror or piece of glass, including microcavity morphologies such as VCSEL, distributed feedback laser, distributed Bragg reflector laser, optofluidic lasers, or SMILES-based gain media in a microfluidic channel for on-chip lasing etc.); and (6) nanoparticle solutions (i.e., a liquid gain medium containing nanoparticles of SMILES). The specific physical state of SMILES components within these morphologies can vary. The SMILES component can disperse (single molecules), clusters of ion pairs (ensemble of molecules <1 nm in diameter), nanoparticles (particles between 1 and 300 nm in diameter), microparticles (particles between 300 nm and 1 mm in diameter), or bulks (solids greater than 1 mm in diameter) or films. The physical state of the SMILES component can be governed by the conditions used in the method of preparation, i.e., polyurethane-based slab media described below will be principally comprised of disperse SMILES and clusters of ion pairs.

Slab, rod, lens, and polyhedral gain media can be prepared using techniques involving reactive polymers, compounding, or photopolymerization. Reactive polymer components can include a method by which the SMILES materials are incorporated into a polymer using precursors that undergo chemical change to form a solid matrix (i.e., formation of polymers from monomers or oligomeric pre-polymers) and can includes classes of polymers including but not limited to polyurethane, polyester, polystyrene, acrylates (e.g., polymethylmethacrylate and polyacrylic acid), polysiloxanes, epoxies, and sol gels (i.e., silica). Compounding can include a method by which the SMILES component are incorporated into a polymer by applying heat and/or mechanical force to a polymeric resin precursor (e.g., polycarbonate pellets) that undergoes a physical change allowing the SMILES component to be dispersed into the polymer host component and includes classes of polymers such as polyester, polystyrene, acrylates (e.g., polymethylmethacrylate and polyacrylic acid), polycarbonates, cyclic olefin copolymer, and transparent derivatives of polypropylene, polyethylene, styrene methyl methacrylate, ionomer resin, styrene acrylonitrile, polylactic acid, and acrylonitrile butadiene styrene. Photopolymerization refers to a method by which the SMILES materials are incorporated into a polymer formed by photopolymerization, specifically with methods of 3-D printing such as stereolithography.

In some exemplary embodiments, the cationic dye can be selected from one or more of the following: Rhodamine 6G; rhodamine B; rhodamine 3B; rhodamine 560; rhodamine 575; rhodamine 640; rhodamine 700; rhodamine 800; fluorescein; oxazine 1; oxazine 4; oxazine 720; Nile Blue; Cresyl Violet; LDS 698; LDS 722; LDS 750; LDS 759; LDS 925, DODC, Dipropyloxadicarbocyanine. In other exemplary embodiments, the anionic dye can be selected from one or more of the following: 7-Hydroxycoumarin-3-carboxylate.

In other embodiments, the counteranion can be selected from one or more of the following: Chloride; bromide; iodide; perchlorate; hexafluorophosphate; tetrafluoroborate; bistriflimide; triflate; sulfate; phosphate; acetate.

The counteranion receptor can be selected from one or more of the following: cyanostar; tricarbazolophane; triazolophane; bambus[6]uril; calix[4]pyrrole.

In other embodiments, the countercation can be selected from one or more of the following: Potassium; cesium. The countercation receptor can be selected from one or more of the following: 18-crown-6; dibenzo-18-crown-6.

The SMILES-doped gain media can include a polymeric host component selected from at least one of the following: polystyrene, polycarbonate, polyurethane, aqueous gels, organogels, sol gels, or glasses.

A SMILES-doped gain media of the present disclosure can be comprised of a polymeric host component and a SMILES component. In one exemplary embodiment, the polymeric host component can be polyurethane, and the SMILES component can be a cyanostar-based dye mixture. Optionally, a crosslinking component can be included. The crosslinking component can be an isocyanate. In other exemplary embodiments, the polymeric host component can be a polycarbonate film and the SMILES component can be a cyanostar-based dye mixture. Other exemplary embodiments can include a polymeric host component is a polyurethane slab and the SMILES component is a cyanostar-based dye mixture. In some exemplary embodiment, the SMILES-doped gain media can include a second polymeric host component.

The SMILES component can have any suitable composition between the charged dye component, the counter ion component and the counter ion receptor. In one exemplary embodiment, the charged dye can be between about 0.10-10 mM composition of LDS 698, the counter ion is perchlorate, and the counter ion receptor is cyanostar. In another exemplary embodiment, the various components of the SMILES component can include the following: a charged dye being between about a 1.0-20 mM composition of DODC, the counter ion can be iodide and the counter ion receptor can be cyanostar. Other suitable charged dyes, counter ions, and counter ion receptors can be utilized.

Preparation of an exemplary embodiment of the gain media using reactive polymers of the present disclosure can include first providing a suitable organic dye that can be dissolved in solvent to a concentration between about 1.0 uM and 200 mM. To this initial solution, about 2.05 molar equivalents of a counter ion receptor, including but not limited to cyanostar can be added to the dye/solvent mixture to create a cyanostar/dye mixture, which can then be added to a liquid monomer solution (i.e., polyethylene glycol, methyl methacrylate, styrene, etc.) and stirred. The working concentration of the dye and cyanostar components can be chosen in such a way that it will yield a concentration between about 0.1 mM and 5 mM in the resulting polymer material, although the exact concentration may vary to best match the pump source and optical cavity of the final laser system.

The polymerization of the polymer material can then be initiated through the addition of a crosslinking component. In some exemplary embodiments, the crosslinking component can include isocyanate added to polyethylene glycol in the case of polyurethanes, or a photosensitizer and external light source to methyl methacrylate or styrene in the case of polymethyl methacrylate or polystyrene, respectively. The mixture can then be homogenized by stirring or sonication and degassed under vacuum to remove any bubbles formed during the homogenization process. The resulting material can then be added to a mold designed to match the final desired shape and the material is placed in a pressure chamber under 35 PSI for several hours to allow polymerization to proceed without the risk of spontaneous bubble formation. When fully solidified, the resulting SMILES-doped polymeric gain media may be removed from its mold.

A detailed preparation for SMILES-doped polymeric gain media applying these guidelines is enumerated in detail below. Polyurethane can be used here as an exemplary embodiment because it is a good polymer matrix for laser gain media owing to its high optical clarity and superior robustness under thermal stress (particularly in comparison to relatively brittle polymers like PMMA or polystyrene) and the relative user-friendly quality of the polymerization reaction. However, other methods of preparation may be used such as polymerization of polystyrene from styrene.

In one exemplary embodiment utilizing a two-part polyurethane resin, about 1.5 g of polyether glycol component can be added to a vial and set aside. The dopant component to be added to the resin (dyes, cyanostar, excess TBA³⁰ (CS₂·PF₆⁻), etc.) can be dissolved in about 300 uL of a suitable organic solvent, including but not limited to methylene chloride to a concentration between about 0.1 mM and 100 mM, with the most typical concentration range sitting between about 5 mM and 20 mM. This mixture can be stirred until the solvent and glycol components homogenize. About 1.5 g of the polyisocyanate component can then be added and the mixture can be stirred. Initial stirring with a spatula can produce a mixture with a very turbid appearance, as the two component parts initially form separated phases owing to their different viscosities. Stirring of the mixture proceeds until the turbidity has cleared and the resin appears to be clear. The stirring may typically be needed for about 30 seconds of continuous stirring. (Note: The mixture will commonly retain bubbles as a result of stirring, but this will be remediated with degassing and subsequent pressurization.)

The mixture can then be immediately taken to a vacuum chamber and placed inside for degassing. The vacuum pump can be engaged, and the pressure reduced until a vacuum of 25 inHg is reached. Degassing can take place at about room temperature (approximately 23° C.). When 25 inHg is reached, the vacuum can be disengaged, and the samples can be allowed to sit under vacuum for 10-30 seconds to allow bubbles to exit the liquid bulk. At this point, an inlet valve can be opened, and the chamber can be allowed to repressurize over the course of about 60 seconds. During this time, the bubbles at the top of the resin will typically be crushed by the increasing pressure, yielding a final mixture that is clear and free of bubbles, particles, or other physical aberrations that may obstruct or scatter light. Taking care not to capture any bubbles, the mixture can be pipetted out of the vial and introduced to a mold that will give the gain medium its final shape, e.g., slab, rod, lens, or polyhedron.

In one exemplary embodiment, preparation of SMILES-doped polymeric gain media of the present disclosure using compounding can include the following steps. A fraction of SMILES material can be integrated into polymer resin at a high concentration (typically between 0.5-10% w/w with respect to the dye component) by dissolving both SMILES and polymer resin in solvent and allowing it to dry or pressing SMILES powder and resin into a puck using a melt press. This tinted material is cut into small chunks and fed into an extruder with additional untinted polymer resin if desired and compounded. The compound material is molded into a solid puck shape using a melt press and polished if needed.

A detailed preparation for PMMA-based gain media applying these guidelines can include first providing about 3g of untinted solid PMMA polymer that can be divided into two roughly equal portions. The two portions can then be pressed into flat discs using a melt press at an applied force of about 2 tons. About 50 mg of SMILES powder can be placed between the two discs and the resulting sandwich can be re-pressed to yield a solid puck. The puck can then be cut into small pieces and added to the microextruder over approximately 7 minutes. The pieces can be mixed in the extruder barrel for a further period of time. In some exemplary embodiment, the time can be about 10 minutes. The compounder outlet valve can be opened, and the extrudate collected and allowed to cool to room temperature. The extrudate can then be pressed into about 1″ wide discs or slabs in the melt press using metal spacers to define the thickness of the sample. In other exemplary embodiments, the frame can additionally act as a spacer. The platens of the melt press can be covered with sheets of polyimide polymer film to ensure a clean release of the sample as well as an optically flat surface.

Film gain media can be prepared using techniques involving spin coating or dropcasting. Preparation of gain media can include the following steps. A stock solution of SMILES in organic solvent can be prepared at a concentration between 1.0 uM and 200 mM, but generally between 0.1 mM and 5 mM. Polymer resin can then be added to this solution in a quantity of 5-500 mg/mL chosen in such a way that it will yield a concentration between 0.1 mM and 5 mM in the resulting polymer material although the exact concentration may vary to best match the pump source and optical cavity of the final laser system. The solution may then be drop-cast onto a substrate and allowed to dry under ambient conditions or spin coated, with the duration and velocity of spinning modified to meet the desired film thickness. Deposition of a resonator structure upon the SMILES film (i.e., Bragg reflector layers) or deposition of SMILES film onto a resonator structure (i.e., a distributed feedback grating) may also be performed to prepare the gain medium. Films may also be prepared in the absence of polymer, forming films composed either solely of dye molecules and ion receptors (i.e., “neat” SMILES) or with additional optically-inert interstitial lattice-forming materials (i.e., addition of [TBA⁺][CS₂·PF₆⁻] if using a cyanostar-based gain medium, where [TBA⁺][CS₂·PF₆⁻] is the salt formed upon addition of two equivalents of cyanostar to one equivalent of tetrabutylammonium hexafluorophosphate).

In one exemplary embodiment, a preparation for polycarbonate-based film gain media can include first providing about 0.5 mg of SMILES powder is dissolved in 5 mL of methylene chloride with 50 mg of poly(bisphenol A)carbonate. The substrate for the film can then be affixed to a spin coater and set to spin at 2000 RPM for about 30 seconds. About 50 uL aliquot of this solution can then be applied to the substrate as the chuck is spinning (dynamic deposition). The substrate can then be removed from the chuck and allowed to dry.

Films prepared from polyurethane can require a significantly different approach to the preparation of thin films. Despite these challenges, polyurethane can be a desirable polymer component because it is (a) resistant to ablation and (b) could be made into thicker films. Additionally, the expansion/contraction cycle of polyurethane curing can be a significant issue in films, where slight deformations resulted in the formation of large voids. As such, a “pre-curing” strategy for the production of film media was developed. For spin-coated films, this involved diluting the polyol and polyisocyante precursors with solvent to a significant degree (10-20% w/w total polymer fraction) and allowing it to cure for ˜100 minutes. The resin, still liquid, can then be spincoated onto glass slides by dynamic deposition and transferred to a 200° F. oven to cure for about 120 minutes. For thicker films (>50 microns), dopant-tinted resin can be prepared in the same manner as with slabs and rods, however, after removing from the vacuum oven, ˜100 uL aliquots of the resin can be applied to the prepared glass plates. A heat gun can then be used to accelerate the curing process. The heat gun can be set to maximum heat and held at a distance of approximately 15 cm from a sample for about 3-5 seconds. A rapid formation of bubbles may be generated, and additional application of the heat gun forced the bubbles to pop. Over time, the aliquot can appear to become more viscous (i.e., the flow of air caused less of a deformation in the droplet) at which point the samples can be allowed to cool for about 30 seconds and then spun on a spincoater. The samples can then be transferred to a pressure pot for curing overnight.

In some exemplary embodiments, SMILES-doped polymeric gain media based upon nanoparticle solutions can be prepared using techniques of flash precipitation or nanoprecipitation. A SMILES-doped gain media can be comprised of a nanoparticulate solution, and the polymeric host component is a liquid host component that can be selected from one or more of the following: organic solvents, water, surfactant- and buffer-stabilized aqueous solutions, or mixtures of water with soluble organic solvents. Methods for the preparation of SMILES nanoparticles using nanoprecipitation can include first providing about 1 mg of laser dye and about 2.20 equivalents of cyanostar and dissolving them in a minimum volume of acetone, possibly with additional optically inert interstitial lattice-forming materials as described above. Separately, a stock solution of Triton X-100 surfactant in water can be prepared (3 mL water, 100 mg Triton). Aliquots of SMILES component dissolved in acetone can be added to these aqueous solutions by rapid injection with a micropipettor, followed by 5 minutes sonication. Following sonication, the mixtures can be placed under vacuum for 5 minutes to remove the remaining acetone. The solutions can be filtered to remove any large precipitates prior to use. The resulting solution is composed of particles with an average diameter of approximately 10 nm as determined by dynamic light scattering and may be used as gain medium in the same way as standard liquid gain media in dye lasers.

In addition to serving as the active component in a laser (i.e., gain medium), SMILES-doped polymeric solids may also be used to produce passive components such as saturable absorbers, filters, or optical coatings. These materials can be prepared in the same way as the gain media described above using the same morphologies (e.g., slabs, lenses, films) but with the critical distinction that the dye component need not be capable of producing a laser beam. In this context, the purpose of the SMILES material is not to amplify light, but rather to manipulate or attenuate it in some way. Similarly, because the material is not intended to contribute to amplification the SMILES material may or may not be situated within the laser cavity/resonator.

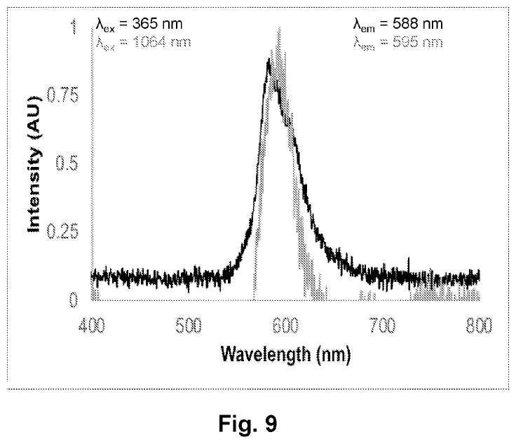

For this purpose, passive components can be prepared in the same manner as SMILES-doped polymeric gain media with the chief difference being the optical properties of the base dye used. For example, as a filter, the dye component selected may only require absorptive properties (i.e., lacking the emissive function of fluorescent dyes). For saturable absorption, the dye component selected may have the property of fluorescence but may also have very short lifetimes, rapid transition of the excited state from singlet-to-triplet, or small stimulated emission cross-sections such that the material does not itself undergo stimulated emission. As an optical coating, the SMILES component may be added to the polymer matrix in higher concentrations than in other embodiments in order to access nonlinear effects like two photon absorption (TPA). For example, a rhodamine 6G-based SMILES polymer film may contain concentrations upwards of 10² mM to efficiently up-convert infrared radiation to visible light emission (e.g., 1064 nm pulses used to produce a 595 nm emission, FIG. 9).

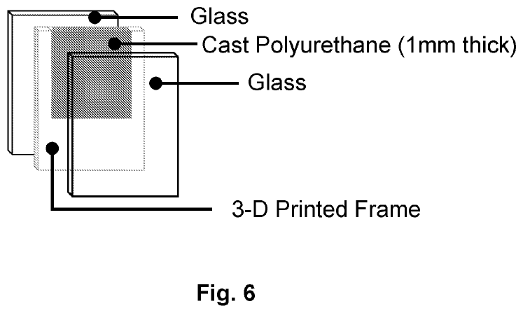

Characterization of SMILES-doped polymeric gain media shows impressive performance improvements over non-SMILES solids. As the most popular dye used in liquid media-based dye lasers, Rhodamine 6G (R6G) can be used as the exemplar for subsequent discussion. For the demonstrations described here, a novel “sandwich” slab morphology was devised are illustrated in FIG. 6.

In one exemplary embodiment SMILES-doped polymer gain media can be generated into a sandwich or slab configuration. Two transparent plates can be provided. The plates can be any suitable plates, including but not limited to glass plates or polymer plates. They are cleaned and a plastic frame produced using 3-D printing can be affixed to one with glue. Polyurethane resin can be prepared as described above and approximately 700 uL of resin is added to the channel within the plastic frame attached to the glass plate. The matching glass plate can then be carefully placed upon the 3D printed frame, sandwiching the liquid resin between. Care is taken to make sure that no bubbles are introduced at this stage. A metal binder clip can then be affixed to both sides of the resulting sandwich. Any resin that is squeezed out of this sandwich can be wiped away with a paper towel wetted with a small quantity of isopropyl alcohol to ensure the surface of the mold is clean. The samples can then be placed into the pressure pot and the pot is sealed. Using an air compressor, the pressure in the pot can be raised to 35 PSI for a duration of at least 3 hours. The pot can then be opened, and the samples placed on a lab bench to cure for about an additional 12 hours, or more commonly, the samples can be left in the pressure pot overnight, allowing for a slow depressurization. Slabs are then withdrawn from the pot and if the resin appears fully cured, the binder clips are removed and set aside for experiment. If significant aberrations are observed (irregular curing within the slab or formation of visible aggregates/precipitates the sample will be discarded. This process ultimately yields a slab with dimensions of 20 mm×20 mm×1 mm and are suitable for use when the polymer is fully solidified. R6G gain media was prepared as both SMILES and a non-SMILES control.

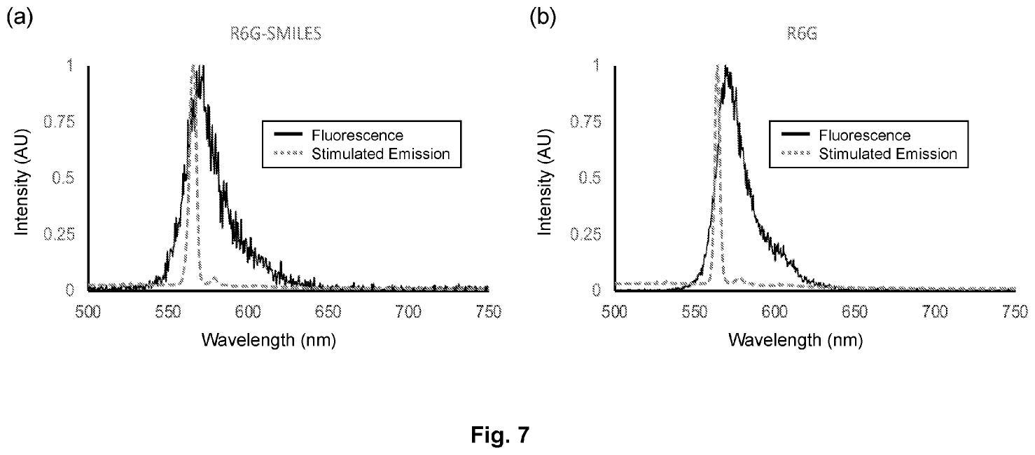

The first step of solid-state media characterization can be to collect the fluorescence spectra of the samples using a fiber optic backscatter probe spectrophotometer with the sample under illumination by a 365 nm LED source. Both samples can have a dye concentration of approximately 0.5 mM, and a gain media thickness of 1 mm. Both samples had intense yellow fluorescence and similar emission maxima (SMILES λₘₐₓ=569 nm, R6G control λₘₐₓ=573 nm, FIG. 7). Subsequently, the samples can be mounted into a cavity composed of a silver mirror as the reflector and a simple beam splitter as the output coupler, separated by approximately 7 cm, and pumped with single pulses from an Nd:YAG laser operating in second harmonic mode (532 nm pump beam). Lasing is immediately evident and upon pumping, an intense pulse of yellow light is generated by the cavity. Several distinct properties of this output can illustrate the hallmarks of a laser beam. First, the output can be a distinctly different color from the pump pulse (green) and of high intensity. Second, the output can always be directed in the plane of the cavity, regardless of the incident angle of the pump. Third, the output cannot be explained by simple reflection of the pump beam. Lastly, the output can show a characteristic “speckle” pattern. Spectroscopic measurements confirmed these qualitative observations through narrow bands are observed at 565.8 nm and 564.1 nm for SMILES and the R6G control, respectively. The full width half max (FWHM) drops below 5 nm for both samples, narrowing to 4.6 nm for SMILES (FIG. 7a) and 3.5 nm for the R6G control (FIG. 7b), conclusively verifying that the pulse is the result of stimulated emission.

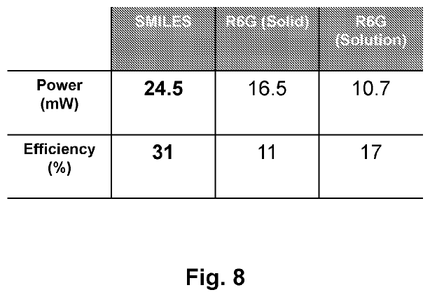

Having confirmed lasing, the relative performance of the solid media would be determined by measuring their power output and conversion efficiency. The results for SMILES are displayed in FIG. 8, showing a maximum power output of 24.5 mW under a 10 Hz pump frequency, corresponding to 2.45 mJ of energy per pulse. The intensity of the pump beam was attenuated using a SMILES-based filter and additional power measurements were taken to produce a plot of pump input power against laser output. From this plot, the SMILES gain medium has a slope efficiency of 31%, and an approximate laser threshold of 0.78 mJ/cm². In contrast, the R6G control medium had a maximum power output of 16.5 mW, corresponding to only 1.65 mJ per pulse. The slope efficiency of the R6G sample was measured to be 11%, with a 1.39 mJ/cm² threshold.

Additionally, tests were done to provide correlating data for liquid SMILE-doped polymeric gain media. A liquid medium gain medium can be designed to match the properties of the solid media and were comprised of a 1 mm path length glass chamber filled with a 0.5 mM methanol solution of R6G. The maximum power output of the liquid medium was 10.7 mW, corresponding to 1.07 mJ per pulse, while the slope efficiency was 17%, with a 0.25 mJ/cm² threshold.

In another instance, a styryl dye (LDS 698) can be used as a comparison. LDS 698 differs from R6G due to its red emission and its long Stokes shift (>200 nm). Sandwich media were prepared in the same way as R6G lasing was confirmed by spectral narrowing of the output beam. In contrast to the R6G samples, the LDS 698 control (non-SMILES) was unable to produce a laser beam under any circumstances. It would appear that this specific dye is incompatible with solid-state lasing, as even low concentration, high-power pump regimes were unable to produce any detectable output. In contrast, the SMILES control consistently emitted a red laser beam, showing a maximum power output of 3.0 mW under a 10 Hz pump frequency using a frequency-doubled Nd:YAG pump laser, corresponding to 0.30 mJ of energy per pulse. The plot of pump input power against laser output shows SMILES gain medium has a slope efficiency of 2.8%, and an approximate laser threshold of 0.16 mJ/cm². As comparison, the liquid gain medium was also studied. Unlike the solid analogue, the liquid medium could produce a laser beam, with a maximum power output of 1.1 mW (0.11 mJ of energy per pulse), a slope efficiency of 2.6%, and an approximate laser threshold of 0.07 mJ/cm².

The SMILES-doped gain media of the present disclosure outperformed control samples, illustrating that the disaggregating effects of SMILES enhances stimulated emission properties of solid dye lasers. Through various dye combinations, it was discovered that the superiority of SMILES gain media over non-SMILES is generally applicable for all dyes. Additionally, SMILES-doped gain media is more powerful (and more efficient) than the liquid embodiment. While the liquid system outperforms SMILES solids in having a lower lasing threshold, in dye systems with minimal cavity losses there is generally a positive correlation between output power and threshold, and so it is consistent with precedent for the weaker gain medium to initiate lasing at a lower pump power. The results highlighted here demonstrate both the viability of SMILES-doped gain medium and its improvement over the materials currently available for dye lasers, both liquid and solid-state.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. SMILES-doped gain media comprising:
a polymeric host component, wherein the polymer component comprises between 90-99.99% of the SMILES-doped gain media by weight; and
a SMILES component wherein the SMILES component comprises between 0.01-10% of the SMILES-doped gain media by weight, and wherein the SMILES component is selected from a group of compounds having at least one of the following formulas:
(charged dye^{m+})x·(counterionⁿ⁻)y·(counterion receptor)z, wherein the charged dye^{m+} is a cationic dye, the counterioⁿ⁻ is an anion, and the counterion receptor is a binding ligand for the counterionⁿ⁻. The values of m, n, x and y are integers greater than or equal to 1 and products of x·n and m·y are identical; or
(charged dye^{m-})x·(counterionⁿ⁺)y·(counterion receptor)z, wherein the charged dye^{m-} is an anionic dye, the counterionⁿ⁺ is a cation, and counterion receptor is a binding ligand for counterionⁿ⁺. The m, n, x and y are integers greater than or equal to 1 and products of x·n and m·y are identical.

2. The SMILES-doped gain media of claim 1, wherein the polymeric host material can be selected from one or more of the following:
polystyrene, polycarbonate, polyurethane, aqueous gels, organogels, sol gels, or glasses.

3. The SMILES-doped gain media of claim 2, where the gain medium has the form of a slab, rod, lens, or polyhedron.

4. The SMILES-doped gain media of claim 2, where the SMILES-doped gain media is contained within a cavity between transparent plates, wherein the cavity thickness is defined by a spacer.

5. The SMILES-doped gain media of claim 1, further comprising a second polymeric host component.

6. The SMILES-doped gain media of claim 1, wherein the SMILES component is comprised of a nanoparticulate solution, and the polymeric host component is a liquid host component that can be selected from one or more of the following:
organic solvents, water, surfactant- and buffer-stabilized aqueous solutions, or mixtures of water with soluble organic solvents.

7. The SMILES-doped gain media of claim 1, wherein the charged dye is selected from one of the major families of dyes consisting of the following:
styryls, xanthenes, trianguleniums, oxazines, triarylmethanes, cyanines, acridines, fluoronones, phenanthridines, polyaromatic hydrocarbons, imides, BODIPYs, coumarins, and squaraines, or a combination thereof.

8. The SMILES-doped polymeric gain media of 1, wherein the counterion receptor is added in excess of the ion to favor formation of a SMILES lattice.

9. The SMILES-doped polymeric gain media of 1, wherein the charged dye is configured to maximize the efficiency of the Förster resonance energy transfer (FRET) process.

10. The SMILES-doped polymeric gain media of claim 1, wherein the ratio of first charged dye:second charged dye is between 100:1 to 1:100.

11. The SMILES-doped gain media of claim 1, wherein the SMILES component includes a ratio of about one part charged dye component to about two parts receptor components.

12. The SMILES-doped gain media of claim 1, wherein the SMILES component includes a ratio of about one part charged dye component to about one part receptor component.

13. The SMILES-doped gain media of claim 1, wherein the polymeric host component is a polyurethane slab or rod, and the SMILES component is a cyanostar-based dye mixture.

14. The SMILES-doped gain media of claim 13, wherein the charged dye is a 0.25-5 mM composition of rhodamine 6g, the counter ion is chloride, and the counter ion receptor is cyanostar.

15. The SMILES-doped gain media of claim 1, wherein the polymeric host component is a polyurethane slab or rod, and the SMILES component is a cyanostar-based dye mixture.

16. The SMILES-doped gain media of claim 15, wherein the charged dye is a 0.25-5 mM composition of oxazine 720, the counter ion is perchlorate, and the counter ion receptor is cyanostar.

17. The SMILES-doped gain media of claim 1, wherein the polymeric host component is a polycarbonate film, and the SMILES component is a cyanostar-based dye mixture.

18. The SMILES-doped gain media of claim 15, wherein the charged dye is a 0.10-10 mM composition of LDS 698, the counter ion is perchlorate, and the counter ion receptor is cyanostar.

19. The SMILES-doped saturable absorber of claim 1, wherein the polymeric host component is a polyurethane slab, and the SMILES component is a cyanostar-based dye mixture.

20. The SMILES-doped gain media of claim 15, wherein the charged dye is a 1.0-20 mM composition of DODC, the counterion is iodide, and the counter ion receptor is cyanostar.
